(19) United States
(12) Patent Application Publication
(10) Pub. No.: US 2012/0286058 A1
(43) Pub. Date: Nov. 15, 2012

(54) Air deodorizing misting apparatus and methods

(75) Inventor: John Lichtenberger, Crystal Lake, IL (US)

(73) Assignee: Ultra-Aire, Inc.

(21) Appl. No.: 13/068,497

(22) Filed: May 12, 2011

(51) Int. Cl. B05B 17/04; B23P 17/04; B05B 1/08

(52) U.S. Cl. 239/11; 239/102.1; 29/890.09

(57) ABSTRACT

An misting apparatus disperses odor-removing mist and comprises a reservoir assembly, misting pack(s), and a fan assembly. The reservoir assembly includes a reservoir and a baffle assembly. A reservoir receives and contains a deodorizing solution. The reservoir comprises an air flow inlet and a mist flow outlet. The baffle assembly is received in the reservoir and forms first and second chambers therewithin. The baffle assembly comprises air flow apertures for enabling air to flow from the first to the second chambers. The packs generate mist within the second chamber. The fan assembly generates air flow at the air flow inlet through the first chamber into the second chamber via the air flow apertures. The air flow into the second chamber thereby forms a mist flow which mist flow is directed through the mist flow outlet into the air surrounding the reservoir assembly for removing odors therefrom.

### BACKGROUND OF THE INVENTION

1. Field of the Invention

The present invention relates generally to an air deodorizing apparatus. More particularly, the present invention relates to a misting apparatus for deodorizing ambient air by way of sending odiferous compound-encapsulating mist into the air.

2. Brief Description of the Prior Art

U.S. Pat. No. 3,711,023 ('023 Patent), which issued to Smith, discloses a Device for Controlling the Evaporation of Volatile Substances Particularly for Use in Air Conditioning Systems. The '023 Patent describes a method of treating odors in which the individual components from which the odor is to be formed, in volatile form, are stored in their own individual receptacles, controlled amounts of said components being released, by evaporation, from their individual storage receptacles, with the various evaporation products being subsequently intermixed to produce the desired odor by first intermixing individual evaporation products into respective streams of air and thereafter intermixing the respective streams of air to effect an intermixing of the various evaporation products therein contained, and a device for practicing such method employing means for producing a plurality of individual air streams, novel individual storage means for respective components to be employed in the creation of such odor, each individual storage means having means associated therewith for effecting a controlled release by evaporation of the associated stored component, such storage means being so arranged with respect to the air stream that the release of the evaporation products of each of the various stored components is effected into a different air stream, means being provided for effecting an intermixture of such air streams subsequent to the introduction therein of the various components.

U.S. Pat. No. 4,268,285 ('285 Patent), which issued to Mason, discloses an Air Freshening Apparatus. The '285 Patent describes an apparatus that dispenses volatized air freshener compound into the room air forcibly moving the air through a prefilter and a high efficiency filter utilizing a fan disposed in the space therebetween. A container of volatile air freshener liquid or gel is positioned in a location such that the air drawn through the prefilter will pass across the top of the container. The container is provided with a lid mounted for movement to open and close the container, the lid being connected to and operable by a control such as a timing mechanism to adjustably regulate the amount of volatized air freshener compound which is permitted to escape into the air passing through the air filter, or the container can be kept totally closed and thus inoperative.

U.S. Pat. No. 4,752,422 ('422 Patent), which issued to Uchida et al., discloses an Ultrasonic Humidifier. The '422 Patent describes an ultrasonic humidifier which includes a spraying chamber for receiving water received therein, a vibrator adapted to make ultrasonic vibrations, a blower, and a perfume case. Ultrasonic waves are applied to the water by the vibrator to produce a water spray in the form of a mist. The water spray is emitted, by driving the blower, into a room by way of a jet of air scented by the perfume to thereby not only moisten the air in the room but also to give forth a pleasing fragrance. The humidifier further comprises an air-feeding suction port hole formed in one side wall of a body of the humidifier. The perfume case is installed at the air suction port hole so as to be demountable from outside the body of the humidifier.

U.S. Pat. No. 5,011,632 ('632 Patent), which issued to Yano et al., discloses an Ultrasonic Fragrance Generation Apparatus. The '632 Patent describes an ultrasonic fragrance generation apparatus for buildings, vehicles, aircraft, and the like, as well as for open areas. In particular it pertains to an ultrasonic fragrance generation apparatus by which means a suitable fragrance may be dispersed into the ambient air at a suitable time in the optimum concentration. By employing a material having increased surface area on the ultrasonic vibrating surface, it is possible with the present invention to generate a fragrant mist at an increased rate.

U.S. Pat. No. 5,030,253 ('253 Patent), which issued to Tokuhiro et al., discloses a Fragrant Air Supplying Method and Supplying System. The '253 Patent describes a fragrant air supplying method, supplying apparatus, and a building having a fragrant air supplying system for supplying fragrant air to the rooms. A fragrant-material supplying means supplies fragrant material to a mist-generating means to generate mist either by blowing air or by vibration produced by an ultrasonic-oscillating means. The mist is blown to a surface portion formed at the end of a fragrant-air separating means which separates evaporated fragrant air from mist. The fragrant air is then introduced into holes formed in a fragrant-air discharging means, in which the place of holes is offset from the surface portion toward the downstream of the fragrant air. The fragrant air is then blown into a distributing passage from the fragrant-air discharging means to mix the fragrant air with conditioned-air supplied by an air-supplying means. This makes fragrance-mixed air for distributing to a predetermined space or rooms for the physical and mental activation of the human body.

U.S. Pat. No. 6,511,050 ('050 Patent), which issued to Chu, discloses a Humidifier. The '050 Patent describes an apparatus which has a source of water such as a tank, joined through an inlet valve to a manifold providing water flow from the inlet valve to a vent stack and a mist stack. The stacks extend upwardly from the manifold and are positioned for sharing a common water level. Both stacks are open at their top. An ultrasonic mist generator is positioned below the mist stack and is enabled for generating a mist within the mist stack. The vent stack provides a water sensor enabled for detecting a preferred water level in the vent and mist stacks and for controlling the inlet valve to maintain this preferred water level.

U.S. Pat. No. 6,793,205 ('205 Patent), which issued to Eom, discloses a Combined Humidifier. The '205 Patent describes a combined humidifier for improving sanitary conditions, which is capable of completely sterilizing bacteria contained in moisture provided to the atmosphere in the form of a cool mist, which is capable of widely spreading the moisture in the air so as to smoothly control the humidity of the atmosphere, by instantaneously evaporating sprayed water during compulsory exhaust of the water with the aid of a blower after spraying water as a mist due to operation of an ultrasonic oscillator, wherein an evaporator having pluralities of radiating plates is installed in a passage for guiding water within the humidifier.

From a consideration of the foregoing, it will be noted that the prior art perceives a need for a misting apparatus comprising means for maximizing effluent mist for the purpose of treating and/or deodorizing rooms laden with malodorous compounds, in which the mist-sourcing solution is maintained within or intermediate first and second solution levels adjacent (a series of) ultrasonic frequency generation means for driving fine mist into the air by way of a dual chambered reservoir assembly. The prior art thus perceives a need for such a misting apparatus, and certain methodology supported thereby as summarized in more detail hereinafter.

### SUMMARY OF THE INVENTION

To achieve these and other readily apparent objectives, the present invention essentially discloses a misting system and/or apparatus with certain methodology associated therewith for dispersing an odor-removing mist into the air space of a room for deodorizing the same. The ultrasonic misting system or apparatus according to the present invention is believed to essentially comprise a mist generation tank assembly or reservoir assembly; certain ultrasonic frequency generation means; certain air flow generation means; and a liquid deodorizing solution usable in combination therewith.

The tank or reservoir assembly preferably comprises a baffle assembly, which baffle assembly provides a number of functions, including division of the reservoir into first and second chambers or compartments; prevention or limitation of splashing intermediate the first and second chambers; control air flow into the second (or expansion) chamber from the first chamber; and restraint of ultrasonic frequency generation packs.

The ultrasonic packs are placed into or supported by the tank bottom of the tank assembly and certain baffle portions of the baffle assembly are placed over the packs. Tank wall(s) extend upwardly from the tank bottom for containing solution within the tank assembly. The air flow-directing apertures of the baffle assembly function to direct air flow into the second expansion chamber from the first chamber. In this regard, it is contemplated that air flow over the ultrasonic packs should preferably be controlled.

The installation of two liquid limit switches provide certain solution level maintenance means when viewed in combination with the supporting circuitry, solution supply, and pump. In this regard, it should be noted that a first liquid limit switch essentially functions to stop the inlet/outlet pump from over filling the tank or reservoir assembly. The second liquid/solution limit switch essentially functions to turn off the ultrasonic packs if the liquid level falls below the low solution level plane.

Certain air flow generation means are attached to the tank top at the air inlet duct or aperture. The fan assembly is tuned to the tank assembly for generating correct air flow. The tank top may then be fastened to the reservoir. Using a gear pump enables the apparatus to move fluid (i.e. odor-removing solution) in two directions. In this regard, it is contemplated that the solution uptake means as exemplified by the may effectively function to empty the tank or reservoir assembly when a given treatment has been completed.

To operate the apparatus, the operator plugs in the apparatus to a power outlet thereby activating the fan assembly for generating air flow into the first (air flow-receiving) compartment. Current is delivered to the fan assembly automatically upon being provided when “plugged in” to a power source. At this state air flow enters the first compartment or chamber being directed downwardly or in a first direction. Air flow is then re-directed and flows through the air flow delivery apertures in a sideways direction orthogonal to the first direction. The air flow, once having entered the second (expansion) compartment or chamber, is re-directed upwardly or in a third direction opposite the first direction and exits the outlet duct or aperture.

The operator may then activate the (fill) pump switch which activates the solenoid switch for directing solution from the supply tank through conduit and the pump into the tank or reservoir assembly until a level switch operates to turn off the pump thereby stopping solution flow into the tank assembly. A timer may also activate the solenoid for starting the ultrasonic packs.

Depending on the treatment setting, the operator may wish to operate one or both ultrasonic packs. The ultrasonic packs each comprise a series of diaphragms that oscillate at ultrasonic frequencies for creating micron sized droplets that form a mist, which mist mixes with the air flow and exits the second (expansion) chamber via the outlet duct or aperture into the air surrounding the apparatus. The mist from the deodorizing solution operates to encapsulate odiferous compounds for deodorizing the air in a given treatment space.

After a treatment has been completed, the operator may hold a switch in the “DRAIN” position until the tank assembly is emptied of all extra solution, which solution is directed in reverse order though the noted conduit into supply tank for conserving solution resources. The fan assembly is powered off once the power cord is removed from the power source outlet.

### BRIEF DESCRIPTION OF THE DRAWINGS

Other features of my invention will become more evident from a consideration of the following brief descriptions of patent drawings:

FIG. 1(a) is a top perspective view of a preferred tank or reservoir assembly according to the present invention with the front wall or panel broken away to show otherwise hidden internal structure, including a preferred baffle assembly.

FIG. 1(b) is a diagrammatic side view type depiction of an alternative tank or reservoir assembly according to the present invention with portions of the front wall or panel broken away to show otherwise hidden internal structure, including an alternative baffle assembly with single ultrasonic frequency pack.

FIG. 1(c) is a diagrammatic side view type depiction of the alternative tank or reservoir assembly otherwise shown in FIG. 1(b) further showing a generic supply tank and pump in connection with the tank assembly.

FIG. 2 is a diagrammatic side view depiction of the apparatus according to the present invention showing the tank or reservoir assembly on the left side of the drawing, upper and lower compartments in the center of the drawing, and a supply tank on the right side of the drawing.

FIG. 2(a) is an enlarged fragmentary view of upper and lower liquid level switches for maintaining the solution level intermediate and upper and lower level.

FIG. 3 is a diagrammatic top view depiction of the apparatus according to the present invention showing the tank or reservoir assembly on the left side of the drawing, and an upper control panel compartment on the right side of the drawing.

FIG. 4 is a diagrammatic top view type depiction of the compartment otherwise structurally situated in inferior adjacency to the upper control panel depicted in FIG. 3.

FIG. 5 is a circuit diagram of the apparatus according to the present invention highlighting the apparatus FILL-MODE circuitry with dotted/broken lines.

FIG. 6 is a circuit diagram of the apparatus according to the present invention highlighting the apparatus DUAL PACK RUN-MODE circuitry with dotted/broken lines.

FIG. 7 is a circuit diagram of the apparatus according to the present invention highlighting the apparatus DRAIN-MODE circuitry with dotted/broken lines.

FIG. 8 is a listing of circuit components otherwise referenced in FIGS. 5-7.

### DETAILED DESCRIPTION OF THE PREFERRED EMBODIMENTS AND METHODOLOGY

Referring now to the drawings with more specificity, the preferred embodiment of the present invention primarily concern an ultrasonic misting system and/or apparatus with certain methodology associated therewith for dispersing an odor-removing mist into the air space of a room for deodorizing the same.

The ultrasonic misting system or apparatus according to the present invention is believed to essentially comprise, in combination a mist generation tank assembly or reservoir assembly as at 10; certain ultrasonic frequency generation means; certain air flow generation means; and a liquid deodorizing solution.

When assembling the system according to the present invention, it is contemplated that the tank or reservoir assembly 10 (central to the practice of the present invention) is first assembled. The tank or reservoir assembly 10 preferably comprises a baffle assembly as at 11, which baffle assembly 11 provides a number of functions.

In this regard, it is contemplated that the baffle assembly 11 functions to divide the reservoir into first and second chambers or compartments as at 100 and 101, respectively; limit splashing intermediate the first and second chambers 100 and 101; control air flow into the second (or expansion) chamber 101 from the first chamber 100; and restrain the ultrasonic frequency generation packs as at 20.

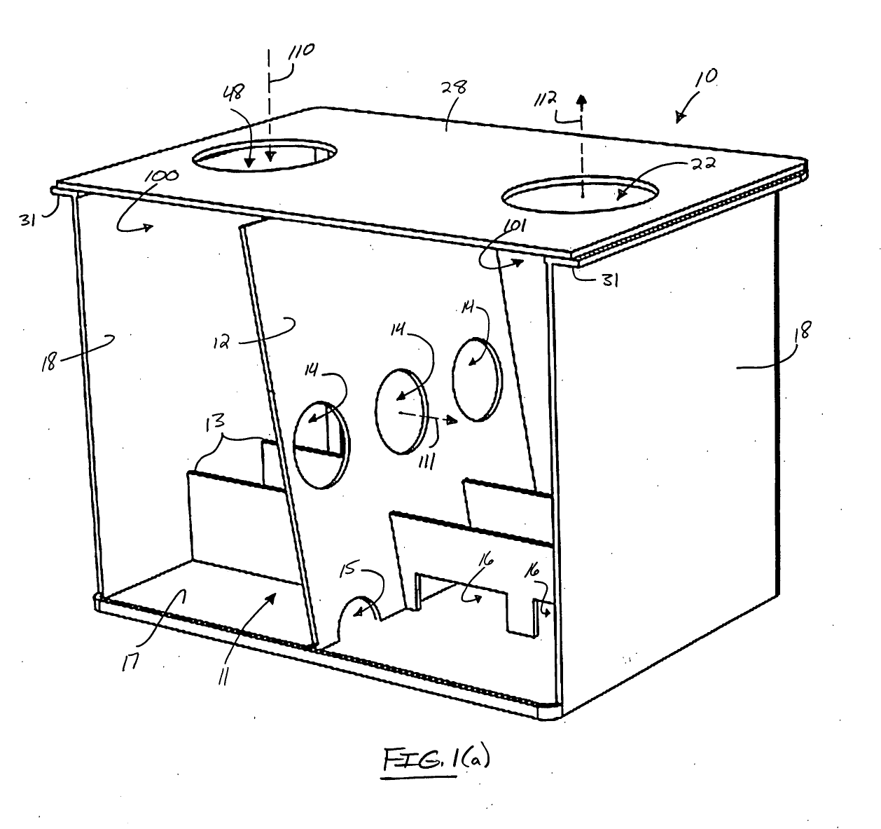

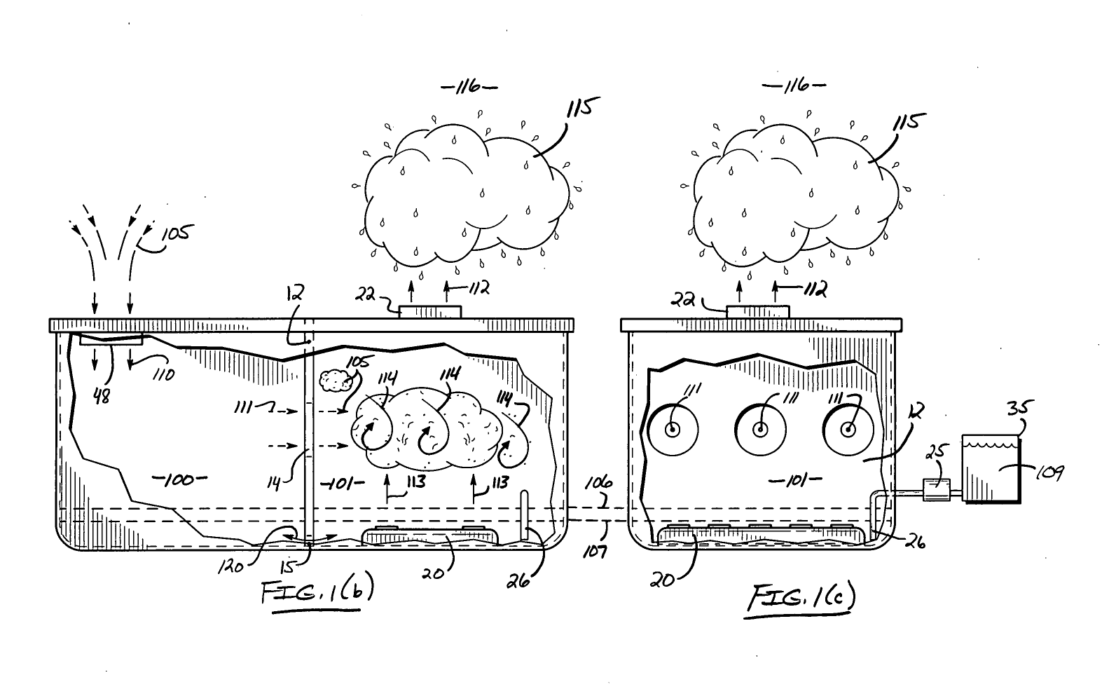

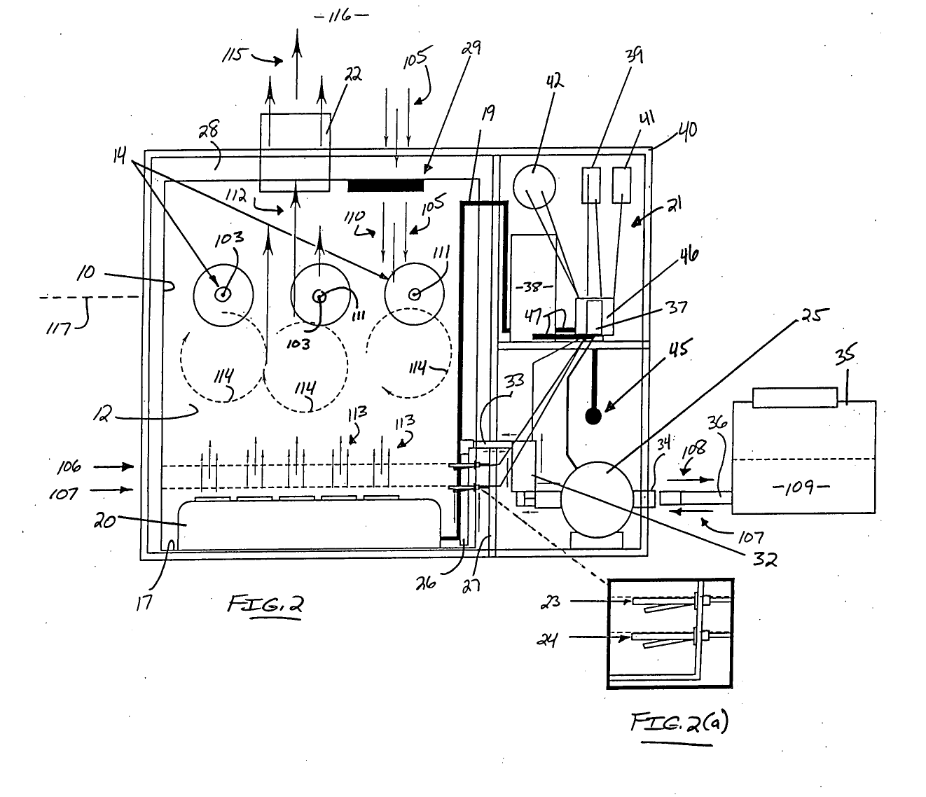

The baffle assembly 11 preferably comprises a chamber-separating, apertured baffle portion as at 12, and parallel, pack-retaining baffle portions as at 13. The baffle portion 12 preferably comprises certain baffle-based air flow means as preferably exemplified by a series of air flow directing apertures as at 14; a series of baffle-based solution flow means as preferably exemplified by solution flow-directing apertures as at 15; and baffle-receiving slots for receiving the baffle portions 13 (not specifically referenced) as may be understood from an inspection of FIG. 1(a). The baffle portions 13 each preferably comprise pack-receiving apertures or structures as at 16.

The ultrasonic packs 20 are placed into or supported by the tank bottom 17 of the tank assembly 10 and the baffle portions 13 of the baffle assembly 11 are placed over the packs 20, the packs 20 being received by the structures 16. The packs 20 may preferably be retained within the reservoir via the pack-receiving apertures or structures 16 of the baffle assembly 11.

Tank walls 18 extend upwardly from the tank bottom 17 for containing solution 109 within the tank assembly 10. Conductors 19 from the ultrasonic packs 20 are preferably positioned over the baffle assembly 11 in a recess made for this purpose. The conductors 19 exit the tank assembly 10 through small holes formed in a tank wall 18 that directs or lead the conductors 19 to the control panel as at 21.

The air flow-directing apertures 14 are preferably circular and comprise 2.5 inch diameters. The aperture axes 103 of the apertures 14 preferably extend in an axis plane as at 104 and essentially function to direct air flow as at 105 into the second expansion chamber 101 from the first chamber 100.

In this last regard, it is contemplated that air flow 105 over the ultrasonic packs should preferably be controlled. It has been found that if the air flow 105 rate is too great, large droplets of water will be forced out the outlet duct as at 22. Further, if the air flow 105 rate is too slow, the required air volume exchange is lacking to properly treat air spaces having relatively greater volume.

The installation of two liquid limit switches 23 and 24 may next be performed and enable/provide certain solution level maintenance means when viewed in combination with the supporting circuitry, solution supply, and pump 25. In this regard, it should be noted that a first liquid limit switch as at 23 essentially functions to stop the inlet/outlet pump 25 from over filling the tank or reservoir assembly 10, and in this regard is positioned at a high solution level plane as at 106. The second liquid/solution limit switch 24 essentially functions to turn off the ultrasonic packs 20 if the liquid level falls below the low solution level plane as at 107 (primarily for safety reasons).

In this last regard, it is note that fluid level is critical for the correct operation of the ultrasonic pack(s) 20. A bulkhead 27 for the fluid inlet/outlet is installed and solution inlet/outlet tubing or conduit 26 is pointed toward the tank bottom 17 of the tank assembly 10. A V-shaped cut (not specifically referenced) is made to the conduit 26 at its terminus so that the conduit 26 does not create an unwanted seal with the tank bottom 17 of the tank assembly 10.

Before installing the tank top 28, certain air flow generation means as exemplified by a fan assembly 29, is first attached (preferably bolted) to the tank top 28 at the air inlet duct or aperture 48. The fan assembly (preferably having a rating for moving 70 cubic feet per minute) is tuned to the tank assembly 10 for generating correct air flow 105. The tank top 28 may then be fastened to the upper flanges 31 of the wall(s) 18 via certain hardware (e.g. machine screws) which hardware may further preferably and simultaneously fasten an air inlet shield to the top of the tank assembly 10. The air inlet shield (not specifically shown) helps direct air intake only from air inlet vents at the control panel side of the apparatus.

The frame 40 for the apparatus is preferably constructed from aluminum so as to reduce the overall weight of the apparatus. Installation of casters (not specifically shown) is believed conducive to apparatus movement and in this regard four corner mounted casters are contemplated. Two of the casters are preferably swivel type casters and two of the casters are stationary type casters. When pulling the machine with a handle, this type of caster arrangement adds to stability.

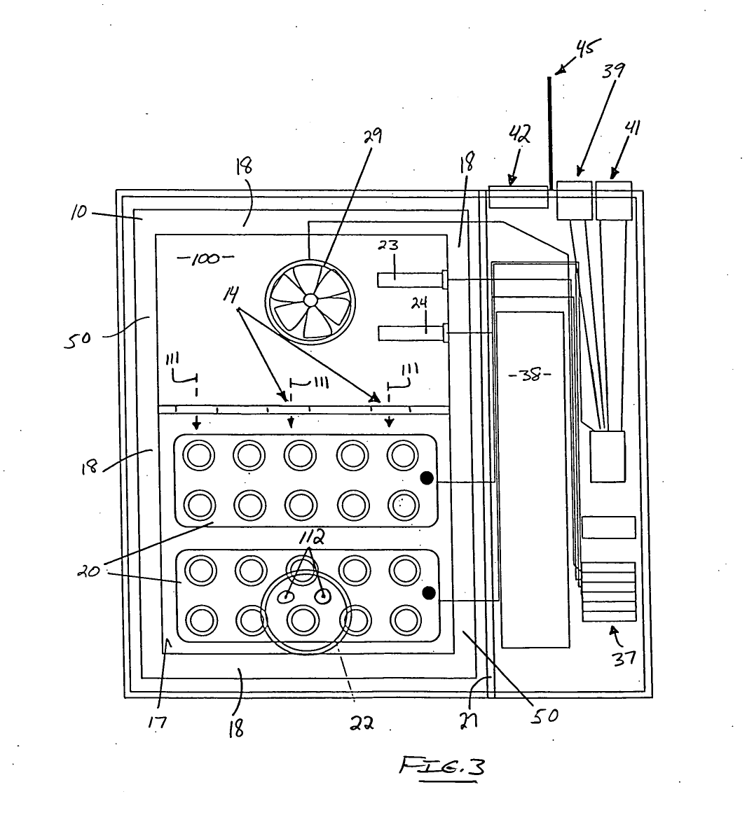

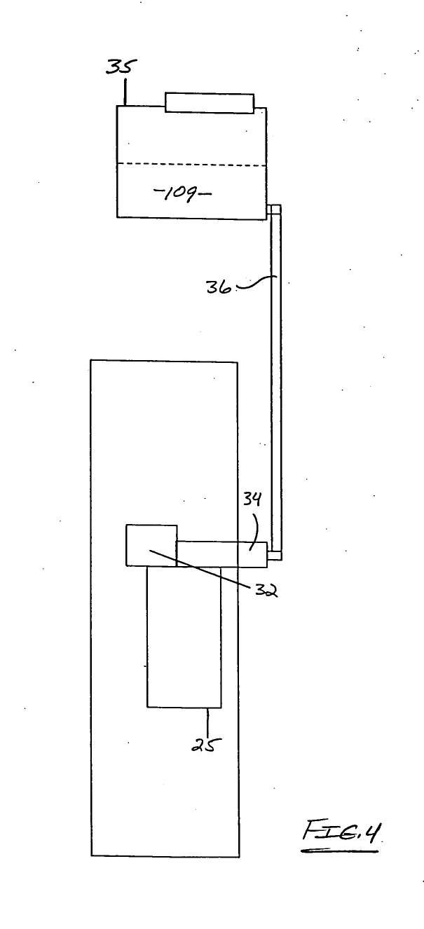

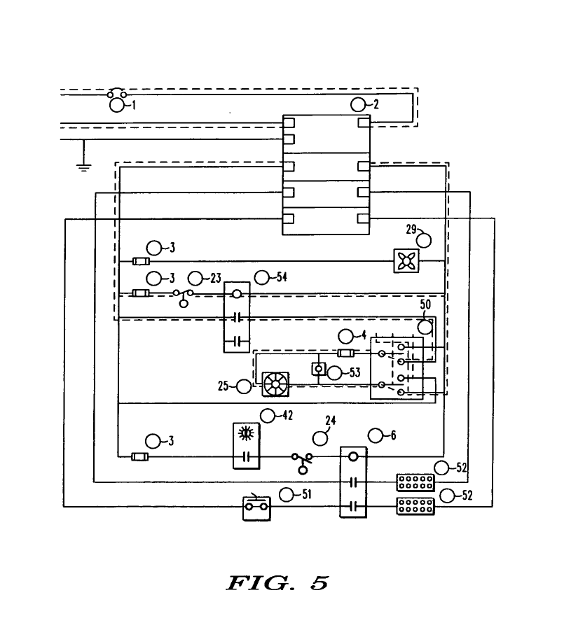

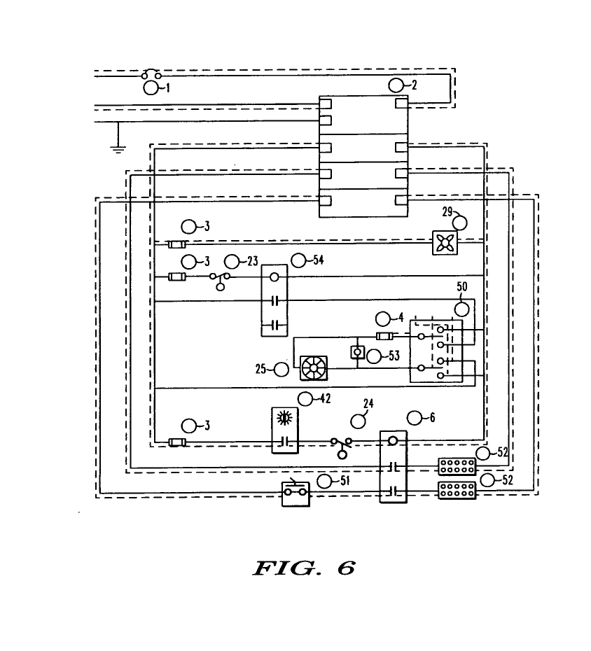

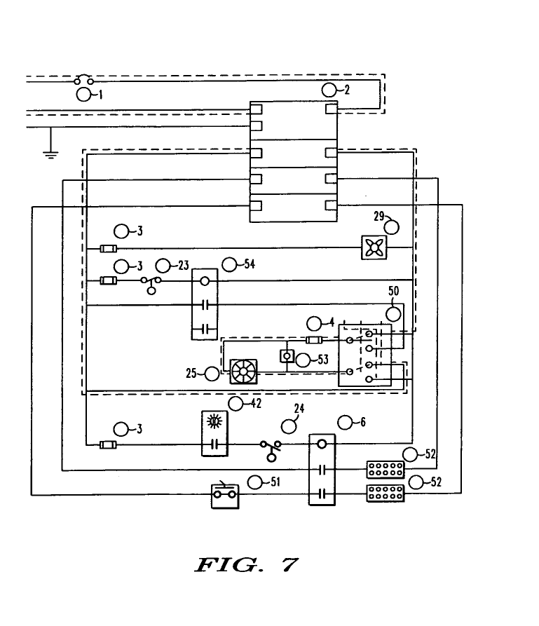

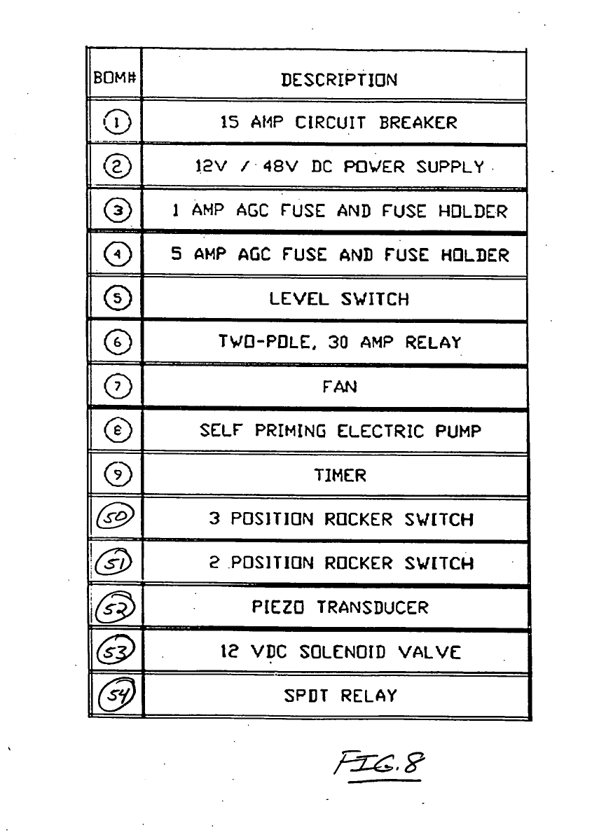

The tank assembly 10 is preferably fastened to the frame assembly via a bracket. The liquid gear pump 25 may then also be bolted to the frame assembly. Using a gear pump 25 enables the apparatus to move fluid (i.e. odor-removing solution) in two directions as depicted at 107 and 108 in FIG. 2 and thus may exemplify certain solution uptake means. In this regard, it is contemplated that the solution uptake means as exemplified by pump 25 according to the present invention may effectively function to empty the tank or reservoir assembly 10 when a given treatment has been completed.

Notably, emptying the tank assembly 10 removes weight from the apparatus and thus easier to move, and the solution resource can be conserved for use in subsequent treatments. Tubing or conduit 33 is routed from the pump 25 to the bulkhead 27 via a solenoid switch as at 32. A quick connect fitting 34 is screwed onto the pump 25 and protrudes out the side of the apparatus. This fitting 34 will be connected to the supply tank 35 (via conduit 36) used to fill and store cleaner solution as at 109. The supply 35 tank can be disconnected and moved separately and is contemplated to retain/contain up to 4 gallons of solution 109. Both the supply tank 35 and tank assembly 10 preferably comprise sealing fittings as to prevent loss of cleaning solution 109.

Each ultrasonic pack 20 according to the preferred embodiment demands 48 volts of direct current and all of the control components preferably use 12 volts direct current. Twelve volts direct current is preferred to 120 volts alternating current for safety reasons. Separate voltage supplies 38 are used for the ultrasonic packs 20 so as to assure no failure of both packs 20 at one time. If overloaded, the power supplies 38 will automatically turn off and not restart until the overload issue has been remedied. The control relay(s) 37 are used to send power to the ultrasonic packs 20 and to control the pump 25 (also preferably 12 volts direct current).

The control panel 21 is loaded with a pump switch 39 (for activating the solenoid switch 32 for fluid flow direction which turns on the pump 25) and a select switch 41 for activating one or both ultrasonic pack(s) 20 as may be needed per any given treatment. The pump switch 39 can be set to ‘Fill’, ‘Off’, or ‘Drain’. Also a mechanical timer 42 is preferably installed and included in the circuitry. It is contemplated that the timer 42 is preferably of a relatively high quality and thus may be more expensive than an electrical timer for the purpose of enhancing ease of use for the end user. A 15 amp circuit breaker for the main power in as at 45 may also be preferably installed wherein the circuit breaker comprises a push button reset accessible from the outside of the apparatus.

The apparatus is then ready to be finally wired. In this regard, the harness 46 is installed and the power leads 47 are placed in electrical communication with the power supply 38, and the apparatus would be ready for testing. With all systems or subcomponents/assemblies passing the testing process, frame-enclosing panels would then be installed, and an aluminum handle would be screwed onto the top of the apparatus. It is contemplated that the handle should be of such construction that it may be folded flat out of the way when not in use.

To operate the apparatus, the operator plugs in the apparatus to a power outlet (not specifically shown) thereby activating the fan assembly 29 for generating air flow 105 into the first (air flow-receiving) compartment 100. Current is delivered to the fan assembly automatically upon plugging in the apparatus. At this state air flow 105 enters the first compartment or chamber 100 being directed downwardly or in a first direction 110.

Air flow 105 is then re-directed and flows through the air flow delivery apertures 14 in a sideways or second direction 111 which second direction 111 is orthogonal to the first direction 110. The air flow 105, once having entered the second (expansion) compartment or chamber 101, is re-directed upwardly or in a third direction 112 opposite the first direction 110 and exits the outlet duct or aperture 20.

The operator may then activate the (fill) pump switch 39 which activates the solenoid switch 32 for directing solution 109 from the supply tank 35 in direction 102 through conduit 36, through pump 25, through conduit 33 and out conduit 26 into the tank or reservoir assembly 10 for tank assembly 10 to the high level plane 106 at which point the high solution level switch 23 operates to turn off the pump 25 thereby stopping solution flow into the tank assembly 10.

Depending on the treatment setting, the operator may wish to operate one or both ultrasonic packs 20, and utilizing switch 41 activates the pack(s) 20. The packs 20 may also be activated via the timer 42. The ultrasonic packs 20 each comprise a series of diaphragms that oscillate at ultrasonic frequencies for creating micron sized droplets that form a mist as at 113, which mist 113 mixes (as at 114) with the air flow 105 and exits the second (expansion) chamber 101 via the outlet duct or aperture 22 into the air surrounding the apparatus. The mist 113 from the deodorizing solution 109 operates to encapsulate odiferous compounds for deodorizing the air in a given treatment space.

Preferably, the ultrasonic pack(s) 20 require at least 0.5 inch of fluid/solution level in superior adjacency to the diaphragms so as to properly develop the mist 113. In this regard, the reader will note that the low solution level plane 107 and switch 24 are positioned such that the plane is slightly elevated relative to the top surfacing of the packs 20. When the solution level reaches the high solution level plane 106, the switch 106 operates to shut off further delivery of fluid/solution to the tank assembly 10.

The operator may set the service time upon the timer 42, which when activated will enable the ultrasonic packs 20 to operate once the low solution level (as at plane 106) has been reached. When the timer 42 reaches a zero setting, the timer 42 operates to shut off the ultrasonic pack(s) 20. After a treatment has been completed, the operator may hold the switch 39 in the “DRAIN” position until the tank assembly 10 is emptied of all extra solution 109, which solution is directed as at 108 in reverse order though the noted conduit into supply tank 35 for conserving solution resources. The fan assembly 29 is powered off once the power cord is removed from the power source outlet.

While the foregoing specifications set forth much specificity, the same should not be construed as setting forth limits to the invention but rather as setting forth certain preferred embodiments and features. For example, as prefaced hereinabove, it is contemplated that the present invention essentially provides an ultrasonic misting apparatus for dispersing an odor-removing mist, the ultrasonic misting apparatus comprising a reservoir assembly as substantially specified; certain (ultrasonic frequency-based) mist generation means as exemplified by packs 20; certain air flow generation means as exemplified by fan assembly 29; and an odor-removing solution (usable in combination with the apparatus) for sourcing a mist for enveloping or encapsulating odiferous compounds for removing odors from the air.

The reservoir assembly preferably comprises a reservoir as at 10 and a baffle assembly as at 11. The reservoir 10 essentially functions to receive and contain a deodorizing solution as at 109, and comprises an air flow inlet 48 and a mist-laden air flow or mist flow outlet as at 22.

The baffle assembly 11 is received in the reservoir 10 and is sized and shaped so as to form a first chamber 100 and a second chamber 101 therewithin. The baffle assembly 11 preferably comprises certain air flow means (e.g. apertures 14) for enabling air to flow from the first chamber 100 to the second chamber 101.

The mist generation means may be preferably defined by certain ultrasonic frequency generation means, which when placed into contact with the solution 109, function to drive mist 113 into the air flow 105 for mixing as at 114. Thus the mist generation means or ultrasonic frequency generation means essentially function to generate mist via an ultrasonic frequency within the second chamber 101.

The air flow generation means are preferably exemplified by a fan assembly as at 29 and essentially function to generate air flow 105 at the air flow inlet 48 through the first chamber 100 into the second chamber 101 via the air flow means or apertures 14. The deodorizing solution is received in the reservoir 10 and placed into contact with the ultrasonic frequency generation means (e.g. ultrasonic pack(s) 20).

The ultrasonic frequency generation means generate an ultrasonic frequency for generating a mist 113 from the solution 109 in the second chamber 101, and the air flow generation means generate air flow 105 into the first chamber 100 through the air flow means into the second chamber 101 thereby forming a mist flow as at 115. The mist flow 115 is directed through the mist flow outlet 22 into the air 116 surrounding the reservoir assembly for removing odors therefrom.

The ultrasonic misting apparatus according to the present invention further preferably comprises certain solution level maintenance means as exemplified by the heretofore described components that function to maintain the solution 109 at a level intermediate the low solution level (as at plane 107) and the high solution level (as at plane 106). In this regard, the switches 23 and 24 along with the supporting circuitry, pump 25, and supply tank 35 with various conduit together function to maintain the solution level at the optimum level.

As earlier noted, the ultrasonic misting apparatus according to the present invention incorporates the use of certain baffle-based air flow means as preferably defined by a series of aligned air flow apertures, wherein each air flow aperture 14 comprising an aperture axis as at 103. The aperture axes 103 extending in an axis plane 117 that extends parallel to the low and high solution levels (as at 107 and 106 respectively).

Thus, the air flow 105 from the first chamber 100 is directed into the second chamber 101 via the air flow apertures 14 at substantially the same distance from the ultrasonic frequency generation means (i.e. packs 20) for enhancing mist flow 115 formation. Further, however, the air flow generation means direct air flow 105 into the first chamber 100 in a first direction 110 orthogonal to the aperture axes 103, and the mist flow 115 is directed from the second chamber 101 in a second direction 112 opposite the first direction 110, said directed air and mist flows 105/115 for enhancing formation and delivery of the formed mist flow.

Notably, the ultrasonic misting apparatus further preferably comprises certain solution uptake means for selectively emptying the reservoir 10 of the odor-removing mist-sourcing solution 109 and storing the solution 109 outside the reservoir 10 for conserving solution resources. In this regard, it is noted that if the solution were to remain in the reservoir when the packs were in idle mode (or when no mist was being driven from the solution), the inherent volatility of various ingredients of the solution would lead the same to evaporate thereby disrupting the preferred formulaic consistency of the remaining solution. The solution uptake means, as exemplified by the associated conduit, circuitry, pump, and supply tank are thus preferably included in the design with an eye toward conserving the solution resources.

It should be noted that the solution uptake means heretofore described are structurally cooperable with the solution level maintenance means in terms of utilizing various components, circuitry, and the like to perform differing functions. Thus, it is contemplated the structural cooperability of the solution uptake means the solution level maintenance means may well function to conserving structural resources.

It will be recalled that the baffle assembly 11 comprises apertures 15 and apertures/structures 16. Bearing these structures in mind, the ultrasonic misting apparatus further preferably comprises certain solution flow means (as exemplified by baffle apertures 15) for enabling solution 109 to readily flow intermediate the first and second chambers 100/101 as at vector(s) 120. Further, the apparatus may be said to comprise certain generator retention means as exemplified the structures 16 for retaining the packs 20 against the bottom 17 in a fixed position within the reservoir 10.

In addition to the foregoing structural considerations, it is further believed that the inventive concepts discussed support certain new methodologies and/or processes. In this regard, it is contemplated that the foregoing structural considerations support both a misting apparatus method of manufacture as well as a method for dispersing an odor-removing mist.

The method of manufacture preferably comprises the steps of providing a solution reservoir as at 10, which solution reservoir comprises a wall (as at 18) having opposed wall portions as at 50; and forming a reservoir baffle as exemplified by baffle assembly 11, which baffle assembly is sized and shaped to extend intermediate the opposed wall portions 50. The reservoir baffle may be outfitted with at least one baffle aperture as at 14.

The solution reservoir may then be outfitted with the apertured reservoir baffle intermediate the opposed wall portions thereby forming first and second reservoir chambers as at 100 and 101. The first chamber is outfitted with certain air flow generation means for generating air flow from the first chamber to the second chamber via the air flow aperture; and the second chamber is outfitted with certain mist generation means for generating mist from a reservoir-received solution (i.e. solution 109).

The method for dispersing an odor-removing mist may be said to comprise the steps of placing a solution for removing odors in contact with certain mist generation means within a first reservoir chamber; and generating mist via the mist generation means thereby forming an odor-removing mist from the solution. Air flow may then be directed into a second reservoir chamber adjacent the first reservoir chamber, whereafter air flow from the second is directed to the first reservoir chambers via air flow conduit extending intermediate said chambers for mixing the air flow with the mist. The mist (flow) may then be directed from the first reservoir chamber into the air surrounding the first reservoir chamber.

Accordingly, although the invention has been described by reference to certain preferred embodiments and certain methodologies, it is not intended that the novel arrangement and methods be limited thereby, but that modifications thereof are intended to be included as falling within the broad scope and spirit of the foregoing disclosures and the appended drawings.

I claim:

1. An ultrasonic misting apparatus for dispersing an odor-removing mist, the ultrasonic misting apparatus comprising:
a reservoir assembly, the reservoir assembly comprising a reservoir and a baffle assembly, the reservoir for receiving and containing a deodorizing solution and comprising an air flow inlet and a mist flow outlet, the baffle assembly being received in the reservoir and forming first and second chambers therewithin, the baffle assembly comprising air flow means for enabling air to flow from the first to the second chambers;
ultrasonic frequency generation means for generating an ultrasonic frequency within the second chamber; and
air flow generation means for generating air flow at the air flow inlet through the first chamber into the second chamber via the air flow means, the deodorizing solution being receivable in contact with said ultrasonic frequency generation means, said ultrasonic frequency generation means for generating a mist from said solution in the second chamber, the air flow into the second chamber for forming a mist flow, the mist flow being directable through the mist flow outlet into the air surrounding the reservoir assembly for removing odors therefrom.

2. The ultrasonic misting apparatus of claim 2 comprising solution level maintenance means, the solution level maintenance means for maintaining the solution level intermediate a low solution level and a high solution level.

3. The ultrasonic misting apparatus of claim 2 wherein air flow means are defined by a series of air flow apertures, each air flow aperture comprising an aperture axis, the aperture axes extending in an axis plane parallel to the low and high solution levels, the air flow from the first chamber thus being directable into the second chamber via the air flow apertures at substantially the same distance from the ultrasonic frequency generation means for enhancing mist flow formation.

4. The ultrasonic misting apparatus of claim 3 comprising solution uptake means, the solution uptake means for selectively emptying the reservoir of said solution and storing said solution outside the reservoir for conserving solution resources.

5. The ultrasonic misting apparatus of claim 4 wherein the solution uptake means are cooperable with the solution level maintenance means for conserving structural resources.

6. The ultrasonic misting apparatus of claim 3 wherein the air flow generation means direct air flow into the first chamber in a first direction orthogonal to the aperture axes, the mist flow being directed from the second chamber in a second direction opposite the first direction, said directed air and mist flows for enhancing formation and delivery of the formed mist flow.

7. The ultrasonic misting apparatus of claim 1 wherein the baffle assembly comprises solution flow means for enabling solution to readily flow intermediate the first and second chambers.

8. The ultrasonic misting apparatus of claim 1 wherein the baffle assembly comprises generator retention means for retaining the ultrasonic frequency generation means in a fixed position within the reservoir.

9. A misting apparatus for dispersing an odor-removing mist, the misting apparatus comprising:
a reservoir assembly, the reservoir assembly comprising a reservoir and a baffle assembly, the reservoir comprising an air flow inlet and a mist flow outlet, the baffle assembly being received in the reservoir for forming first and second chambers and comprising air flow means for enabling air to flow from the first to the second chambers;
mist generation means cooperable with the second chamber for generating a solution mist therein; and
air flow generation means cooperable with the first chamber for generating air flow from the first chamber to the second chamber via the air flow means, the air flow for forming a mist flow in the second chamber, the mist flow being directable through the mist flow outlet into air surrounding the reservoir for removing odors therefrom.

10. The misting apparatus of claim 9 comprising solution level maintenance means for maintaining a deodorizing solution level intermediate a low solution level and a high solution level.

11. The misting apparatus of claim 10 wherein the air flow means direct air flow in an air flow plane parallel to the low and high solution levels, the air flow from the first chamber thus being directed into the second chamber at a substantially uniform distance from the mist generation means for enhancing mist flow formation.

12. The misting apparatus of claim 10 comprising solution uptake means, the solution uptake means for selectively emptying the reservoir of said solution and storing said solution for conserving solution resources.

13. The misting apparatus of claim 12 wherein the solution uptake means are cooperable with the solution level maintenance means for conserving structural resources.

14. The misting apparatus of claim 9 wherein the baffle assembly comprises solution flow means for enabling solution to readily flow intermediate the first and second chambers.

15. The misting apparatus of claim 9 wherein the baffle assembly comprises generator retention means for retaining the mist generation means in a fixed position within the reservoir.

16. A misting apparatus for dispersing an odor-removing mist, the misting apparatus comprising:
a reservoir assembly, the reservoir assembly comprising a reservoir, the reservoir comprising an air flow inlet and a mist flow outlet;
mist generation means for generating a solution mist within the reservoir;
air flow generation means cooperable with the reservoir for generating air flow through the reservoir; and
solution level maintenance means for maintaining a deodorizing solution level intermediate a low solution level and a high solution level, the air flow for forming a mist flow in the reservoir, the mist flow being directable through the mist flow outlet into air surrounding the reservoir for removing odors therefrom.

17. The misting apparatus of claim 16 wherein the air flow generation means direct air flow in an air flow plane parallel to the low and high solution levels for enhancing mist flow formation.

18. The misting apparatus of claim 16 comprising solution uptake means, the solution uptake means for selectively emptying the reservoir of said solution and storing said solution for conserving solution resources.

19. The misting apparatus of claim 18 wherein the solution uptake means are cooperable with the solution level maintenance means for conserving structural resources.

20. The misting apparatus of claim 16 wherein the reservoir assembly comprises a baffle assembly, the baffle assembly being received in the reservoir for forming first and second chambers therein and comprising air flow means for enabling air flow from the first to the second chambers.

21. The misting apparatus of claim 20 wherein the baffle assembly comprises solution flow means for enabling solution to readily flow intermediate the first and second chambers.

22. The misting apparatus of claim 20 wherein the baffle assembly comprises generator retention means for retaining the mist generation means in a fixed position within the reservoir.

23. A misting apparatus method of manufacture, the method comprising the steps of:
providing a solution reservoir, the solution reservoir comprising a wall, the wall comprising opposed wall portions;
forming a reservoir baffle, the reservoir baffle being sized and shaped to extend intermediate the opposed wall portions;
forming a baffle aperture in the reservoir baffle;
outfitting the solution reservoir with the apertured reservoir baffle intermediate the opposed wall portions thereby forming first and second reservoir chambers;
outfitting the first chamber with air flow generation means for generating air flow from the first chamber to the second chamber via the air flow aperture; and
outfitting the second chamber with mist generation means for generating mist from a reservoir-received solution.

24. The method of claim 23 comprising the step of outfitting the solution reservoir with solution level maintenance means for maintaining a solution level intermediate a low solution level and a high solution level.

25. The method of claim 24 comprising the step of forming a series of coplanar air flow baffle apertures in the reservoir baffle, said baffle apertures being positioned in parallel relation to the low and high solution levels.

26. The method of claim 23 comprising the step of outfitting the reservoir with solution uptake means for selectively emptying the reservoir of said solution and storing said solution.

27. The method of claim 23 comprising the step of forming a series of solution flow baffle apertures in the reservoir baffle, the solution flow apertures for enabling solution to readily flow intermediate the first and second chambers.

28. A method for dispersing an odor-removing mist, the method comprising the steps of:
placing a solution for removing odors in contact with mist generation means within a first reservoir chamber;
generating mist via the mist generation means thereby forming an odor-removing mist from the solution;
directing air flow into a second reservoir chamber adjacent the first reservoir chamber;
directing air flow from the second to the first reservoir chambers via air flow conduit extending intermediate said chambers; and
directing the mist from the first reservoir chamber into the air surrounding the first reservoir chamber.

29. The method of claim 28 comprising the step of maintaining the solution level in the first reservoir chamber via solution level maintenance means, the solution level maintenance means for maintaining the solution level intermediate a low solution level and a high solution level.

30. The method of claim 29 comprising the step of directing air flow from the second to the first reservoir chambers via a series of coplanar air flow apertures, the air flow apertures each axially extending in an aperture plane parallel to the low and high solution levels, the air flow from the second reservoir chamber thus being directed into the first reservoir chamber via the air flow apertures at substantially the same distance from the low and high solution levels for enhancing mist formation.

31. The method of claim 28 comprising the steps of:
directing air flow into the second reservoir chamber via the air flow generation means in a first direction orthogonal to the aperture plane; and
directing the mist from the first reservoir chamber in a second direction opposite the first direction, said directed air flow and mist for enhancing mist formation and delivery.

32. The method of claim 28 comprising the step of directing solution flow intermediate the first and second reservoir chambers via solution flow conduit formed intermediate said reservoir chambers.
